(19) United States
(12) Patent Application Publication
(10) Pub. No.: US 2021/0321840 A1
(43) Pub. Date: Oct. 21, 2021

(54) SUCTION GENERATION DEVICE

(71) Applicant: C Robotics AS, Kristiansund N (NO)

(72) Inventor: Kjell STORVIK, Kristiansund (NO)

(21) Appl. No.: 17/346,085

(22) Filed: Jun. 11, 2021

Related U.S. Application Data
(63) Continuation of application No. PCT/NO2021/050102, filed on Apr. 16, 2021.

(30) Foreign Application Priority Data
Apr. 17, 2020 (NO) 20200469

(51) Int. Cl. A47L 7/00; A47L 9/00; A01K 80/00

(52) U.S. Cl. CPC A47L 7/0085; A01K 80/00; A47L 9/00; A47L 7/0004

(57) ABSTRACT

A suction generation device, comprising a fluid supply port and a suction port in fluid communication with an expulsion port and a matter collection arrangement to receive a fluid from the expulsion port; the suction device comprises a suction conduit connected to the suction port and a handheld appliance that assists in collecting matter in a fluid; the suction generation device configurable to receive a fluid supply at the fluid supply port and flow to the expulsion port that reduces pressure at the suction port to cause a fluid flow through the suction port carrying solid particles entrained therein; the suction generation device is configured to combine the fluid supply and the fluid flow to form the expulsion fluid, and direct the expulsion fluid through the expulsion port into the matter collection arrangement configured to hold a proportion of the solid particles entrained in the fluid flow therein.

### CROSS REFERENCE TO RELATED APPLICATIONS

This application is a continuation of International Application No. PCT/NO2021/050102, filed on Apr. 16, 2021, which claims priority to Norwegian Application No. 20200469, filed on Apr. 17, 2020, which are incorporated herein by reference in their entirety.

### TECHNICAL FIELD

The present disclosure relates to a suction generation device for the collection of matter in a fluid and a method for collection of matter in a fluid using a suction generation device.

### BACKGROUND ART

In recent years, people have become increasingly aware of, and increasingly able to monitor, changes in their external environment. Advancements in technology have meant that it is easier than ever to monitor the global environment, while factors such as climate change and pollution have increased awareness of changes in the global environment.

Over the last decade, one such change that has been observed has been the disappearance of underwater kelp forests, for example those off the North American Pacific coast. At present, it is believed that the reason for the disappearance of these kelp forests is multifold. However, one major factor appears to be a recent surge in the number of sea urchins inhabiting the sites of the underwater kelp forests. Large numbers of sea urchins are able to sweep across the sea floor, and can devour the kelp forest quicker than it is able to regenerate, resulting in the complete disappearance of swathes of kelp forest.

As present the surge in the population of sea urchins in regions of kelp forest shows little sign of abating. The destruction of the underwater kelp forests is having an adverse impact both on the local environment, and also on local economies that are reliant in some way on the presence of the kelp forests. Therefore, action is required to remedy the situation and prevent the further destruction of kelp forests.

In order to limit damage to other parts of the local ecosystem, a targeted approach to reducing the number of sea urchins is desirable. Some present approaches have involved sending divers to the sea floor to physically remove the problem urchins. However this technique can be slow and the work of the divers may be limited by the volume of urchins they are able to carry around. While faster methods of removal of sea urchins may be possible (e.g. by trawling), these are generally undesirable as they may additionally remove other marine life from the sea floor, as well as cause damage to the underwater geology. There is therefore requirement to provide a means for fast and efficient removal of sea urchins from the sea floor, having minimal impact on the surrounding environment.

### SUMMARY

It is an object of the present disclosure to mitigate, alleviate or eliminate one or more of the above-identified deficiencies and disadvantages in the prior art and solve at least the above mentioned problem. According to a first aspect there is provided a suction generation device for the collection of matter in a fluid, comprising: a fluid supply port; a suction port; an expulsion port, the fluid supply port and the suction port being in fluid communication with the expulsion port; and a matter collection arrangement configured to receive an expulsion fluid from the expulsion port; the suction generation device being configurable to receive a fluid supply at the fluid supply port such that a fluid flowing from the fluid supply port to the expulsion port generates a reduction in pressure at the suction port to cause a fluid flow through the suction port, the fluid flow comprising solid particles entrained therein; and the suction generation device being configured to combine the fluid supply at the fluid supply port and the fluid flow through the suction port to form the expulsion fluid, and direct the expulsion fluid through the expulsion port and into the matter collection arrangement, the matter collection arrangement being configured to hold a proportion of the solid particles entrained in the fluid flow therein.

According to a second example there is a suction generation device configured to be operated at least partially submerged in water.

According to a third example there is a suction generation device wherein the suction generation device comprises a buoyancy arrangement to permit control of the buoyancy of the suction generation device.

According to a fourth example there is a suction generation device wherein the buoyancy arrangement comprises a floatation device and tether of adjustable length.

According to a fifth example there is a section generation device comprising a housing, the housing comprising the fluid supply port, the suction port and the expulsion port.

According to a sixth example there is a suction generation device wherein the buoyancy arrangement is connected to the housing via the tether of adjustable length.

According to a seventh example there is a suction generation device wherein the matter collection arrangement is configured to permit passage of the expulsion fluid, and restrict passage of the solid particles entrained in the expulsion fluid.

According to an eighth example there is a suction generation device wherein the matter collection arrangement comprises a mesh net for restricting passage of solid particles in the matter collection arrangement.

According to a ninth example there is a suction generation device comprising a suction conduit connected to the suction port at one end thereof.

According to a tenth example there is a suction generation device wherein the suction conduit comprises an appliance at a second end thereof for assisting in collecting matter in a fluid.

According to an eleventh example there is a suction generation device wherein the appliance comprises a handle and a brush.

According to a twelfth example there is a suction generation device comprising a fluid supply conduit connected to the fluid supply port at one end thereof, and in communication with a fluid supply at another end thereof.

According to a thirteenth example there is a suction generation device comprising a fluid expulsion conduit connected at one end to the expulsion port and at another end to the matter collection arrangement.

According to a fourteenth example there is a suction generation device configured to be operated in a subsea environment.

According to a fifteenth example there is a suction generation device wherein the matter collection arrangement of the suction generation device is at a surface location.

According to a sixteenth example there is a suction generation device wherein the fluid supply port, the suction port and the expulsion port are configured in an eductor arrangement.

According to a second aspect there is provided a method for collection of matter in a fluid using a suction generation device, comprising: providing a suction generation device, the suction generation device comprising: a fluid supply port; a suction port; an expulsion port, the fluid supply port and the suction port being in fluid communication with the expulsion port; and a matter collection arrangement configured to receive an expulsion fluid from the expulsion port; the suction generation device being configurable to receive a fluid supply at the fluid supply port such that a fluid flowing from the fluid supply port to the expulsion port generates a reduction in pressure at the suction port to cause a fluid flow through the suction port, the fluid flow comprising solid particles entrained therein; providing a fluid flow to the fluid supply port; receiving a fluid flow comprising solid particles therein through the suction port and directing the fluid flow to the matter collection arrangement to hold a proportion of the solid particles.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features and advantages of the present disclosure, will be more fully appreciated by reference to the following illustrative and non-limiting detailed description of examples of the present disclosure, when taken in conjunction with the accompanying drawings.

FIGS. 1A and 1B show an elevation and plan view of an example of a suction generation device.

FIGS. 2A, 2B, and 2C show further detail of a suction generation device with some attached components.

FIG. 3 illustrates one use of the suction generation device of the previous Figures.

FIG. 4 illustrates a cross sectional view of a suction generation device similar to that depicted in FIGS. 2A-C.

FIGS. 5A and 5B illustrate an elevation and plan of a further exemplary suction generation device.

FIGS. 6A and 6B show further detail of the suction generation device of FIGS. 5A and 5B with some attached components.

FIG. 7 illustrates the suction generation device of FIGS. 6A-B in use.

FIG. 8 is a cross sectional view of a suction generation device similar to that depicted in FIGS. 5A-B.

### DETAILED DESCRIPTION

The present description provides an improved suction generation device for the collection of matter in fluid and method for collection of matter in fluid using suction generation device. According to an example embodiment there is provided a suction generation device for the collection of matter in a fluid, comprising: a fluid supply port; a suction port; an expulsion port, the fluid supply port and the suction port being in fluid communication with the expulsion port; and a matter collection arrangement configured to receive an expulsion fluid from the expulsion port; the suction generation device being configurable to receive a fluid supply at the fluid supply port such that a fluid flowing from the fluid supply port to the expulsion port generates a reduction in pressure at the suction port to cause a fluid flow through the suction port, the fluid flow comprising solid particles entrained therein; and the suction generation device being configured to combine the fluid supply at the fluid supply port and the fluid flow through the suction port to form the expulsion fluid, and direct the expulsion fluid through the expulsion port and into the matter collection arrangement, the matter collection arrangement being configured to hold a proportion of the solid particles entrained in the fluid flow therein.

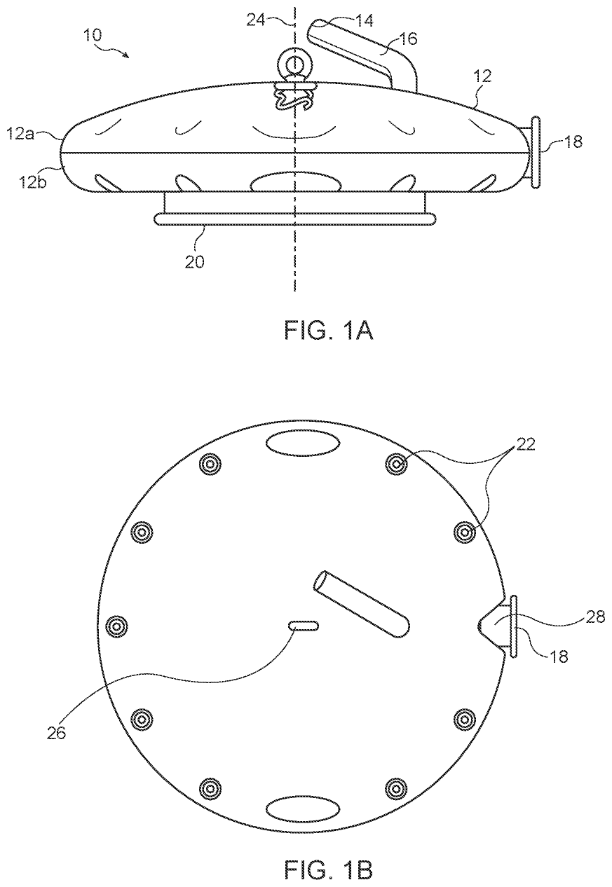

Illustrated in FIGS. 1A and 1B are an elevation and plan view of one example of a suction generation device 10. The suction generation device comprises a housing 12, a fluid supply port 14, which in this case is defined by a fluid supply arrangement 16, a suction port 18 and an expulsion port 20.

As depicted, the housing 12 comprises a first section 12a and a second section 12b (which may be considered to be an upper section 12a, and a lower section 12b as oriented as shown, and as may be the orientation of operation) that are coupled together to define the housing 12, and are held together via a coupling arrangement 22. In this case, the coupling arrangement is shown as a nut and bolt style connection, with each section of the housing 12a, 12b comprising a plurality of apertures for receiving a bolt, which is then held in one of said apertures by a corresponding nut. However, it should be appreciated that other means of connecting the first and second housing sections 12a, 12b are possible. For example, the first and second housing sections 12a, 12b, may be held together via a snap-fit style connection, may be bonded together (e.g. by chemical means, by welding, or the like).

An aperture is additionally defined in the housing 12 through which the fluid supply arrangement 16 extends, in this example. Here, the fluid supply port 14 is defined by a conduit extending through the housing 12. The conduit comprises a bend therein, such that the conduit initially extends from the housing at a first angle relative to a central axis 24 of the suction generation device 10, and deviates to extend at a second angle relative to the central axis 24 (e.g. a non-zero angle). Such a configuration may facilitate ease of attachment of a fluid supply to the suction generation device 10, while at the same time ensuring that the fluid supply is able to provide adequate suction to the suction generation device 10. Although the fluid supply port 14 is illustrated as being defined by a fluid supply arrangement 16 extending from the housing 12, the fluid supply port 14 may be defined (at least in part) by the housing 12, and in some cases having a separate fluid supply arrangement 16 may not be necessary.

Extending laterally relative to the central axis 24 is the suction port 18. In use, suction is provided at the suction port such that a fluid flow is induced therethrough. In this example, the suction port 18 is defined by a suction tube 28, although in other examples, the suction port 18 may be defined by, for example, the housing 12 itself.

Extending from a lower surface of the suction generation device 10, and in this example defined by the second section 12b is the expulsion port 20. As is visible in the drawings, the diameter of the expulsion port may be larger than the diameter of the fluid supply port 14 and the suction port 18. In use, a fluid flowing through the fluid supply port 14 and through the suction port 18 may be combined inside the suction generation device, and ejected via the expulsion port 20, as will be described in further detail later. As illustrated, the expulsion port 20 is largely in line with the central axis 24 of the suction generation device 10. However, the skilled reader will appreciate that alternative positioning of the expulsion port 20 (or, indeed, any of the previously described ports) may be possible depending on design requirements.

Described in more detail later, and not shown in FIGS. 1A-B, the housing 12 of the suction generation device 10 may define a flow path extending from each of the fluid supply port 14 (and/or the fluid supply arrangement 16), the suction port 18 and the expulsion port 20. In some examples, the flow path extending from the fluid supply port 14 and from the suction port 16 may combine to form the flow path extending from or to the expulsion port 20.

The suction generation device 10 additionally comprises a connection point 26. The connection point 26 may be used to connect any necessary component to the suction generation device 10. For example, the connection point 26 may be connected to a positioning mechanism (not shown in FIGS. 1A-B), which may be used to hold the suction generation device 10 in place, during use. The positioning mechanism may take the form of a cable or tether, which may be connected to a buoyant object, such as a vessel or a buoy (e.g. in the case where the suction generation device is operated at least partially submerged underwater or subsea), or may be connected to a fixed structure. The connection point 26, when connected to a positioning mechanism, may assist to position the suction generation device 10, while still permitting a degree of movement of the suction device 10.

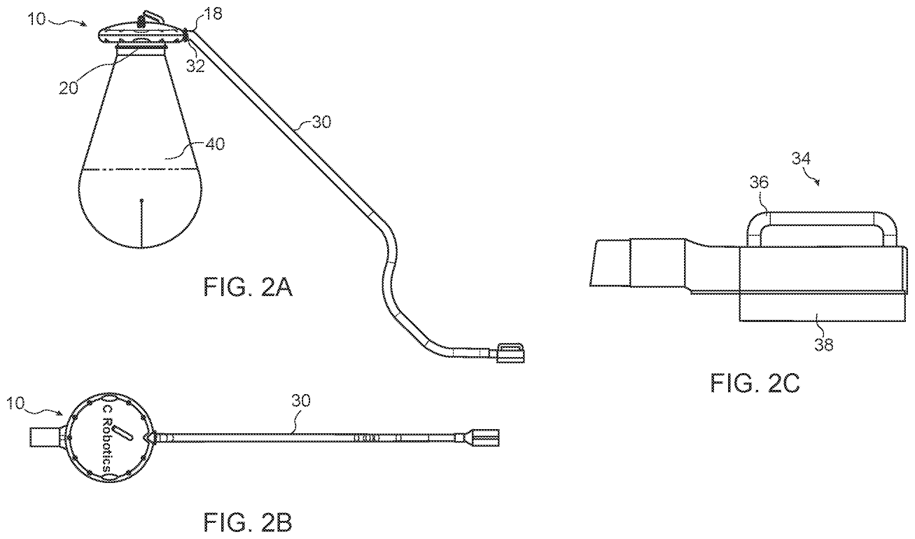

FIGS. 2A-C show further detail of a suction generation device 10 with a number of components attached thereto. The suction generation device 10 is substantially as is described in FIGS. 1A-B. In this example, there is shown a suction conduit 30 connected to the suction port 18 via a suction connection arrangement 32. The suction conduit 30 may be connected to the suction port 18 by any appropriate means. The connection arrangement 32 may take the form of a first connection component defined on or by the suction port 18 (or the suction tube 28), and a second connection component defined on or by an end of the suction conduit 30. For example, the suction connection arrangement may take the form of a threaded profile defined by the suction port 18, while the suction conduit 30 may comprise a corresponding threaded profile thereon, such that each are able to be screwed together. Additionally or alternatively, the suction port 18 and suction conduit 30 may each comprise a flange, which are able to be mated together, and affixed by means of a screw or bolt arrangement. The suction connection arrangement 32 may additionally comprise a seal or sealing arrangement, configured to restrict or prevent fluid exiting between the first and second components thereof.

In the illustrated example, the suction conduit 30 takes the form of a long section of tubing, which in this case is flexible. At one end of the suction conduit 30 is an appliance 34 that may assist the user in the collection of matter within a fluid. Here, the appliance 34 is illustrated as being hand held. In this example, the appliance 34 comprises a handle 36, although in other examples, the appliance may simply be small enough to be held in the hand of a user, or may comprise a portion sized to allow gripping of the appliance by hand. The appliance may additionally comprise a contact component 38 for bringing into contact with matter to be collected, so as to disturb said matter and thus facilitate connection thereof. The contact component 38 may be, for example, a brush, a scraper and/or a scrubber, and the appliance 34 may be sized so that it is suitable for being held in the hand of a user so as to permit the user to accurately and selectively disturb and/or remove matter within a fluid.

Attached to the expulsion port 20 is a matter collection arrangement 40. In FIG. 2A, the matter collection arrangement 40 is depicted as a bag or pouch, and in this is made from a mesh material (e.g. a mesh net). Having a mesh material may function to permit some material exiting the expulsion port 20 to pass through the collection arrangement 40, such as fluids and very small particles, while larger particles may be retained within the collection arrangement 40. The mesh size of the collection arrangement 40 may be selected by a user so as to allow only particles of a desired size to be retained therein. In addition, the collection arrangement 40 may be made from a flexible material. As such, when no or few particles are retained in the collection arrangement 40, then the size of the collection arrangement may be relatively compact, thereby minimally impeding a user.

In one example, the suction generation device 10 may be used in a subsea environment to collect creatures, such as sea urchins, from a subsea environment. In this particular example, the appliance 34, suction conduit 30 and suction port 18 may be sized large enough to allow sea urchins to pass therethrough (e.g. the suction conduit may have a diameter of 8 cm, 10 cm, 11 cm, 12 cm, 15 cm, 20 cm, any size therebetween, or the like, depending on the size of the size of the sea urchins to be collected), while the mesh size of the collection arrangement 40 may be selected so as to permit passage of fluids and small rocks therethrough, but to retain sea urchins therein (e.g. a mesh size of 0.1 cm, 0.5 cm, 1 cm, 2 cm, 2.5 cm, 3 cm, any size therebetween, or the like may be used). In this way, the suction generation device can be used effectively to collect sea urchins from an underwater environment, which may be a subsea environment.

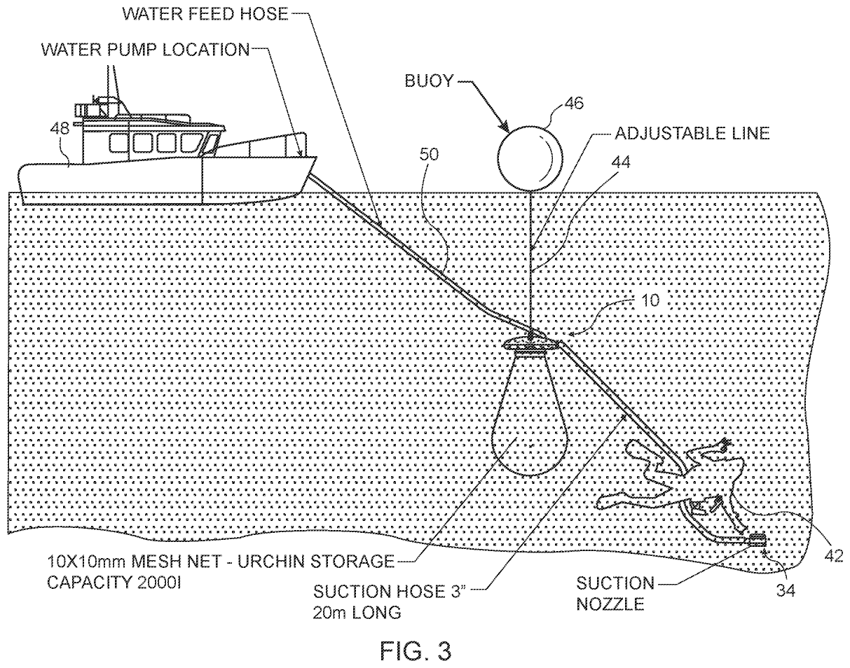

Such a scenario is illustrated in FIG. 3, which shows a user 42 in a subsea environment operating the suction generation device 10. In this example, the suction generation device 10 is held in place via a connection line 44 to a buoyancy arrangement 46—in this case a buoy. While the buoyancy arrangement 46 may permit some degree of movement of the suction generation device 10, (i.e. lateral movement, and vertical movement, to some degree), it may stop the suction generation device 10 from sinking too deep in the water.

The suction generation device 10 is also connected to a vessel 48 in this example, which contains a fluid supply. The fluid supply is able to be provided from the vessel to the suction generation device 10 via a fluid supply conduit 50, which may be a flexible connection that provides a fluid connection between the vessel 48 and the fluid supply port 14 (see FIGS. 1A-B). In this case, the buoyancy arrangement 46 assists to hold the suction generation device 10 at a location to avoid overstretching of the fluid supply conduit, thereby assisting to preserve the connection between the vessel 48 and the suction generation device 10. In some examples, the fluid supply conduit 50 may provide further functionality other than providing a fluid supply. For example, it may be possible for the fluid supply conduit 50 to additionally provide electrical cabling, for example for the operation of electrical devices and/or sensors on the suction generation device 10, or that are held/worn by a user subsea.

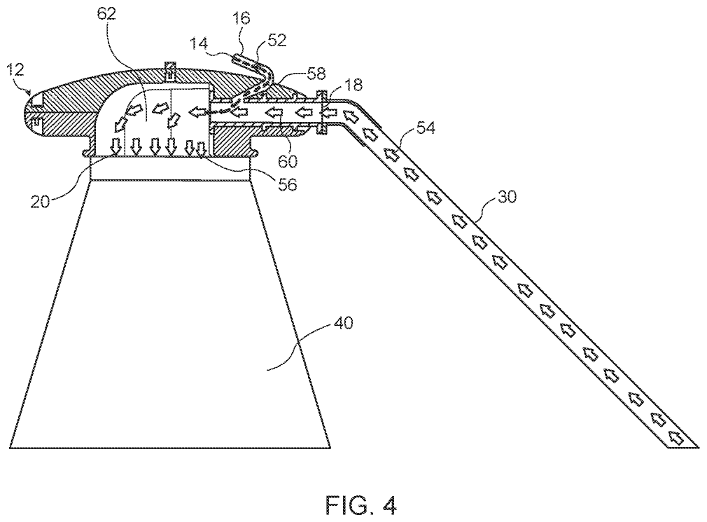

Internal detail of the suction generation device 10 is illustrated in FIG. 4. In this Figure, a cross-section is shown of the suction generation device 10 as shown in FIGS. 2A-C, which includes a fluid supply port 14, a suction port 18 and an expulsion port 20 having a matter collection arrangement 40 in the form of a mesh bag attached thereto.

In this illustration, arrows 52 show a fluid flow through the fluid supply port 14 and into a fluid supply flow path 58, which in this example is partially defined by the housing 12, and partially defined by the fluid supply arrangement 16, towards a location interior to the housing. In other examples, the fluid supply flow path 58 may be defined entirely by the housing 12, or entirely by the fluid supply arrangement 16. In addition, arrows 54 are also used to show a fluid flow through the suction conduit 30 and through the suction port 18, into a location internal to the housing 12 via a suction flow path 60, which is partially defined by the suction tube 28 (see FIG. 1B) and partially defined by the housing in this example. As can be seen, the fluid flow illustrated by arrows 52 through the fluid supply port 14, and the fluid flow illustrated by the arrows 54 through the suction port 18 is combined inside the housing and to a flow depicted by arrows 56. The fluid flow is combined at a junction between the fluid supply flow path 58 and the suction flow path 60. This combination forms the expulsion flow path 62, which directs fluid flow in an axially outward direction from the housing 12, through the expulsion port 20, and into the matter collection arrangement 40.

In the configuration shown, the fluid 52 through the fluid supply port 14 creates a drop in pressure at the junction between the fluid supply flow path 58 and the suction flow path 60, by means of the Venturi effect. As such, the fluid flow from the fluid supply flow path 58 passing the junction of the suction flow path 60 provides the suction at the suction port 18. The degree of suction provided can be adjusted by adjusting the volume flow rate of fluid through the fluid supply port 14. In this way, the user is able to use the suction generation device 10 to create a controllable amount of suction, while also being able to use the fluid supply to direct collected matter into a collection arrangement 40. The configuration shown may be preferable to using, for example, a simple fluid pump to directly provide suction for collecting matter, because the degree of suction provided may be reduced compared to that provided by a fluid pump, thereby resulting in less damage to the subsea/underwater environment when used. Further, the provision of a supply of fluid assists to direct the collected matter into a convenient location.

Although not shown in FIG. 4, the device 10 may comprise a pressure relief valve, for reasons of safety. The pressure relief valve may be located, for example, on the fluid supply arrangement 16, and may be in fluid connection with the fluid supply flow path 58. The pressure relief valve may extend from the fluid supply arrangement adjacent the housing, or in some examples the pressure relief valve may extend through the housing such that it is in fluid connection with the fluid supply flow path 58. The pressure relief valve may permit fluid connection of the fluid supply flow path 58 with an external location, and may permit flow from the fluid supply flow path 58 to said external location. For example, the pressure relief valve may permit fluid flow only in the direction from the fluid supply flow path 58 to said external location (which may be an external subsea location in the described examples). In some examples, the pressure relief valve may extend from the suction tube 28, and optionally through the housing 12, to connect the expulsion flow path 62 to an external location. In some examples, there may exist a plurality of pressure relief valves as described. For example, there may exist a pressure relief valve fluidly connecting the fluid supply flow path 58 with an external location, and a second pressure relief valve fluidly connecting the expulsion flow path 62 to an external location. In some examples, there may be a pressure relief valve, or a plurality of pressure relief valves located on the suction conduit 30 and/or the fluid supply conduit 50.

The pressure relief valve may be configured to only activate when the pressure in the flow path to which it is fluidly connected (e.g. the fluid supply flow path 58 or the expulsion flow path 62) exceeds a predefined value. As such, the pressure relief valve may comprise a biasing member, such as a spring, to ensure that it permits fluid flow therethrough only when the pressure of the fluid in the relevant flow path exceeds a predefined limit. The pressure relief valve may assist in cases where there is a blockage in the fluid supply flow path 58 and/or the expulsion flow path 62. In such cases, the pressure relief valve may prevent damage caused to the device as a result of excess pressure buildup in the device (e.g. damage to a conduit or seals within the device).

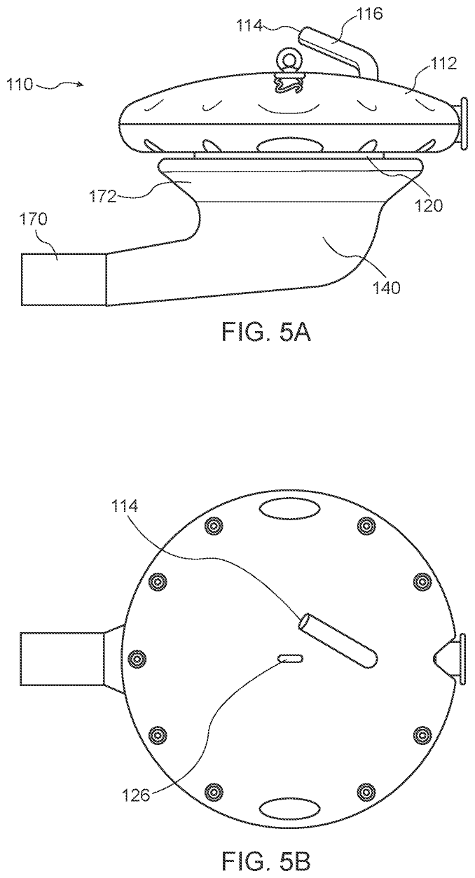

Illustrated in FIGS. 5A and 5B is a further example of a suction generation device 110. This example has many features in common with the previously described example. Therefore, where components are alike, similar reference numerals have been used, augmented by 100.

As in the previous example, this suction generation device comprises a housing 112 having a fluid supply port 114 and fluid supply arrangement 116, as well as an expulsion port 120. In common with the previous example, there is also provided a connection point 126 on the housing 112 of the suction generation device 110.

In contrast to the previously described FIGS. 1A-B, there is shown in this example a collection arrangement 140. This collection arrangement 140 comprises an attachment portion 172, which adjoins a section of hose 170 (which may be considered to be a fluid expulsion conduit). This collection arrangement 172 is configured to directly receive fluid flow from the expulsion port 120, and transport that fluid flow (comprising particulate matter entrained therein) to an external location. The external location may be a surface location, for example, a vessel such as a boat or ship, where the expelled fluid flow and matter entrained therein may be held.

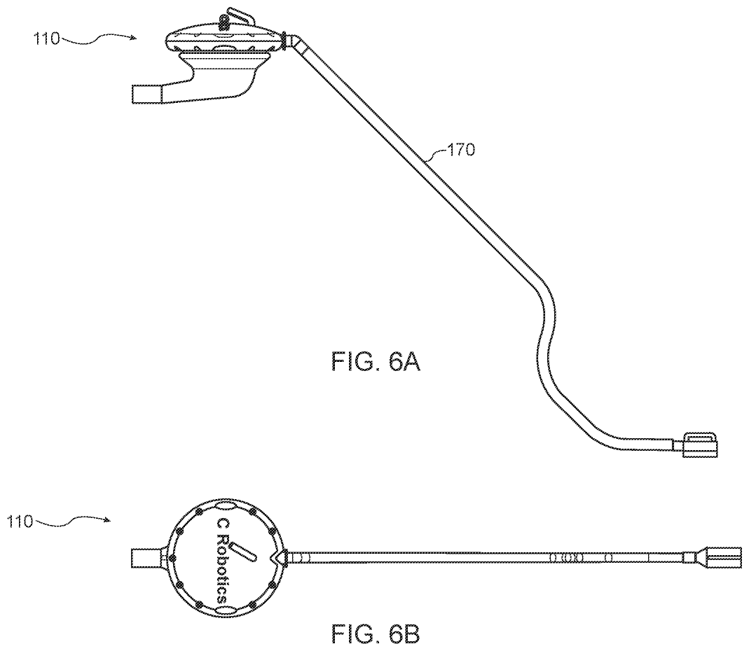

FIGS. 6A and 6B illustrate the suction generation device 110, with a suction conduit 130 attached, in a similar way to the example of FIGS. 2A-B described previously.

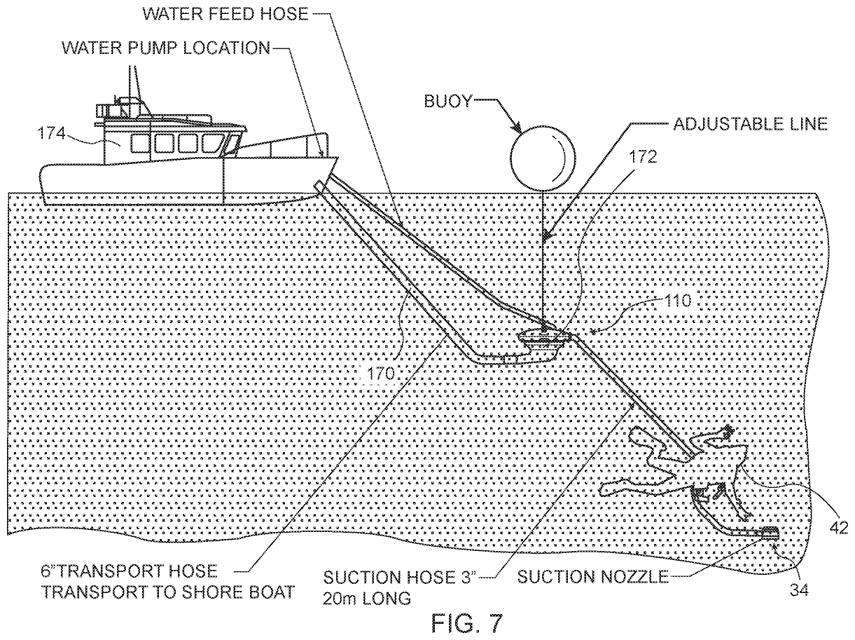

FIG. 7 is similar to the previously described FIG. 3, in that it shows a user 142 in the subsea environment, operating a suction generation device 110. For the sake of brevity, features in common with FIG. 3 will not be described again.

Here, the matter collection arrangement 140 comprises an attachment portion 172 and a hose 170. In contrast to the previous example that illustrated the matter collection arrangement 40 as a mesh bag or pouch which permitted passage of fluid and small particles therethrough, in this example all (or substantially all) of the fluid and matter entrained therein is collected in the attachment portion 172 and directed towards a floating vessel 174 via the hose 170. The skilled reader will appreciate that the fluid may equally be transmitted via hose 172 to any appropriate location. For example, it may be transmitted to a fixed structure, or to an onshore location. Once the fluid reaches the vessel, the user may be able to take appropriate action. For example, the user may choose to separate the fluid from the particles entrained therein on the vessel, and may further choose to separate different types of collected solid matter. In one example, where the suction generation device 110 is used to collect sea urchins from a subsea location, the user may choose to separate the collected sea urchins from the fluid, and also from other particulate matter that may have been collected by the suction generation device 110.

In some cases, it may be possible to reuse fluid produced from the hose 170 on the vessel as the fluid supply to operate the suction generation device 110.

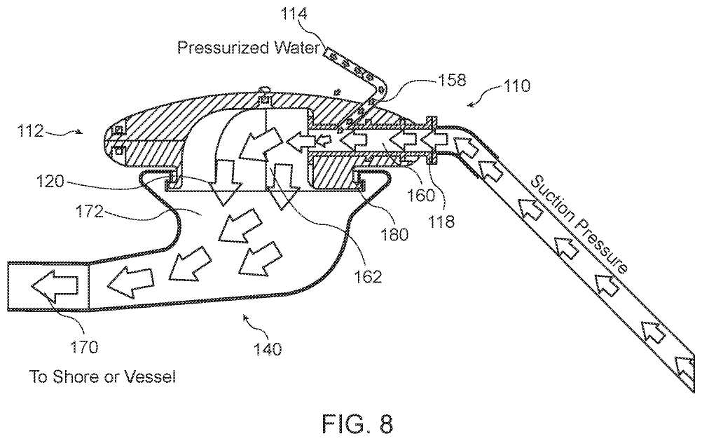

FIG. 8 illustrates a sectional view showing internal detail of the suction generation device 110. In many ways, FIG. 8 is similar to the previously described FIG. 4, and therefore a detailed description of identical features will not be provided. It should be noted that, in both cases, the geometry of the suction generation devices 10, 110 may be identical, and therefore a single suction generation device 10, 110 may be used in the examples shown in both FIGS. 4 and 8.

As in the previous example, the suction generation device comprises a housing 112, having a fluid supply port 114, a suction port 118, and an expulsion port 120. The housing 112 at least partially defines a fluid supply flow path 158 and a suction flow path 160, which combine to form an expulsion flow path 162. The expulsion flow path 162 directs expelled fluid with matter entrained therein towards the matter collection arrangement 172, where the expelled fluid is then directed through hose 170.

In this example, and in the previously described suction generation device 10, 110, the housing comprises a lip 180 that surrounds the expulsion port 120. The lip 180 may completely surround the expulsion port 120, or may surround a proportion thereof. The lip 180 may extend in a continuous section, or may comprise a plurality of broken, or separate, sections. The lip 180 may be used to assist in attaching the matter collection arrangement 170 to the housing 120 of the suction generation device 10, 110. In some examples, the connection may be a threaded connection, a snap-fit connection, a bolted connection, or the like.

What is claimed is:

1. A suction generation device for collection of matter in a fluid, comprising:
a fluid supply port;
a suction port;
an expulsion port, the fluid supply port and the suction port being in fluid communication with the expulsion port; and
a matter collection arrangement configured to receive an expulsion fluid from the expulsion port;
a suction conduit connected to the suction port at one end thereof and a handheld appliance at a second end thereof, the handheld appliance being for assisting in collecting matter in a fluid;
the suction generation device being configurable to receive a fluid supply at the fluid supply port such that a fluid flowing from the fluid supply port to the expulsion port generates a reduction in pressure at the suction port to cause a fluid flow through the suction port, the fluid flow comprising solid particles entrained therein; and
the suction generation device being configured to combine the fluid supply at the fluid supply port and the fluid flow through the suction port to form the expulsion fluid, and direct the expulsion fluid through the expulsion port and into the matter collection arrangement, the matter collection arrangement being configured to hold a proportion of the solid particles entrained in the fluid flow therein.

2. The suction generation device of claim 1, configured to be operated at least partially submerged in water.

3. The suction generation device of claim 2, wherein the suction generation device comprises a buoyancy arrangement to permit control of the buoyancy of the suction generation device.

4. The suction generation device of claim 3, wherein the buoyancy arrangement comprises a floatation device and tether of adjustable length.

5. The suction generation device of claim 4, comprising a housing, the housing comprising the fluid supply port, the suction port and the expulsion port.

6. The suction generation device of claim 5, wherein the buoyancy arrangement is connected to the housing via the tether of adjustable length.

7. The suction generation device of claim 1, wherein the matter collection arrangement is configured to permit passage of the expulsion fluid, and restrict passage of the solid particles entrained in the expulsion fluid.

8. The suction generation device of claim 1, wherein the matter collection arrangement comprises a mesh net for restricting passage of solid particles in the matter collection arrangement.

9. The suction generation device of claim 1, wherein the handheld appliance comprises a handle and a brush.

10. The suction generation device claim 1, comprising a fluid supply conduit connected to the fluid supply port at one end thereof, and in communication with a fluid supply at another end thereof.

11. The suction generation device of claim 1, comprising a fluid expulsion conduit connected at one end to the expulsion port and at another end to the matter collection arrangement.

12. The suction generation device of claim 1, configured to be operated in a subsea environment.

13. The suction generation device of claim 11, wherein the matter collection arrangement of the suction generation device is at a surface location.

14. The suction generation device of claim 1, wherein the fluid supply port, the suction port and the expulsion port are configured in an eductor arrangement.

15. A method for collection of matter in a fluid using a suction generation device, comprising:
providing a suction generation device, the suction generation device comprising:
a fluid supply port;
a suction port;
an expulsion port,
the fluid supply port and the suction port being in fluid communication with the expulsion port; and
a matter collection arrangement configured to receive an expulsion fluid from the expulsion port;
the suction generation device being configurable to receive a fluid supply at the fluid supply port such that a fluid flowing from the fluid supply port to the expulsion port generates a reduction in pressure at the suction port to cause a fluid flow through the suction port, the fluid flow comprising solid particles entrained therein;
providing a fluid flow to the fluid supply port; and
receiving a fluid flow comprising solid particles therein through the suction port and directing said fluid flow to the matter collection arrangement to hold a proportion of said solid particles.
